(19) United States
(12) Patent Application Publication
(10) Pub. No.: US 2011/0038998 A1
(43) Pub. Date: Feb. 17, 2011

(54) Automatic machine for user-controlled production of a food product

(76) Inventor: René M. KOHLI, Freienstein (CH)

Correspondence Address: BIRCH STEWART KOLASCH & BIRCH, PO BOX 747, FALLS CHURCH, VA, 22040-0747, US

(21) Appl. No.: 12/848,814

(22) Filed: Aug. 2, 2010

(30) Foreign Application Priority Data
Jul. 31, 2009 (EP) 09 405 131.5

(51) Int. Cl. A47J 31/42; A47J 31/40; A23F 5/26

(52) U.S. Cl. 426/433; 99/286; 99/282

(57) ABSTRACT

In the method as claimed in the invention savory substances which can be perceived by gustatory, olfactory and/or haptic means are extracted from the precursor product (24) by an automatic machine (30) and transferred into the food product (27). In doing so the extraction of the savory substances is influenced by way of user-controlled setting of at least two technical parameters of the automatic device (30) in order to produce the desired quality of the food product (27). The technical parameters (17) are set by a user-controlled electronic transmission circuit which proceeding from user-selected values of human sensory attributes (12) and based on a predetermined sensory profile (7) of the precursor product (24) controls the technical parameters (17) in production. The transmission circuit works especially according to the principle of an artificial neural network (15). In this way, on the one hand the desired taste, smell or composition of the food product (27) can be attained much more precisely, and on the other hand, more quality versions can be achieved.

### TECHNICAL DOMAIN

The invention relates to an automatic machine for user-controlled production of a liquid food product, specifically a ready-to-drink coffee beverage, from a precursor product, specifically from roasted coffee beans. The automatic machine comprises a machine for extracting savory substances which can be perceived by taste and/or smell from the precursor product and for their transfer into the food product. There are at least two process control elements for user-controlled setting of two adjustable technical parameters of the automatic machine and for influencing the extraction of savory substances in order to be able to produce the desired quality of the food products. Here one of the process control elements is a grinder for coffee beans. Furthermore the invention relates to method for producing food products.

### PRIOR ART

Automatic machines for producing ready-to-drink beverages are common. There is an almost unimaginable variation of semiautomatic or fully automatic machines especially for producing coffee beverages. While the desired coffee (normal, espresso, milky coffee, etc.) is produced in fully automatic coffee makers by simply pressing a button, in certain semiautomatic coffee makers the user is able to influence the amount of coffee, the grind, amount of water, or even the water pressure (WO 2008/105017). This is especially important from the standpoint of the users who would like to influence the gustatory and/olfactory quality of the coffee beverage based on their personal preferences.

US 2006/188620 A1 (Gutwein) discloses a method for producing an individually suited beverage in which “delayed mixing” and/or “delayed filtering” and optionally “delayed dilution” are combined in order to consider the most varied preferences of the users with reference to “body”, “character” and “consistency”. The method is based on an industrially produced coffee powder which then is charged into the coffee maker as an “extract” or “concentrate”. The described method works with ambient pressure and not with increased brewing pressure.

EP 1 929 905 A1 (Rhea Vendors) discloses a coffee maker which works with increased pressure in the brew chamber. The coffee powder is compressed with a piston in the brew chamber before the water is admitted. To control the brewing pressure in the brew chamber, there is a piezoelectric valve at the output of the brew chamber. This makes it possible to continuously control the brew pressure and to change it if necessary.

Criteria are known according to which the quality of a coffee beverage can be assessed in terms of the human senses. They include attributes such as “bitterness”, “acid”, “body”, “fruitiness”, “floweriness”, “cream”, etc. They are thus attributes which directly indicate the sensation of taste or smell. The known automatic coffee makers allow only stipulation of technical parameters (such as grind, pressure, temperature, etc.). Which olfactory or gustatory quality of the coffee beverage results for a certain choice of technical parameters must be elaborated by the user by many attempts (if the machine allows variation of technical parameters at all). In addition, the olfactory and gustatory quality depends on the initial product (i.e. on the coffee beans and their roasting). Correct profiling requires a complex method in which, proceeding from a certain type of coffee and a certain production, a group of experienced test personnel consumes and evaluates a series of different coffee beverages.

In practice this leads to optimization of the coffee production process being abandoned due to the high test cost and to the automatic coffee makers typically producing coffee with unsatisfactory quality.

### DESCRIPTION OF THE INVENTION

The object of the invention is to devise a method which belongs to the initially mentioned technical domain and which allows reproducible production of a food product (specifically a coffee beverage) in the desired quality.

This object is achieved in an apparatus by the features of Claim 1 and in a method by the features of Claim 12. As claimed in the invention a method for user-controlled production of a liquid food product is used, specifically a ready-to-drink coffee beverage, from a precursor product, specifically from roasted coffee beans, from a precursor product.

In this method savory substances which can be perceived by taste and/or smell are extracted from the precursor product by an automatic machine and are transferred into the food product. The automatic machine comprises a machine which as the process control elements has at least one grinder for coffee beans. Here, by way of user-controlled setting of at least two technical parameters of the automatic machine, the extraction of savory substances is influenced in order to produce the desired quality of the food product. One of the at least two technical parameters is the grind of the grinder. The technical parameters are set by a user-controlled electronic transfer circuit which proceeding from user-selected values of human sensory attributes and based on a predetermined sensory profile of the precursor product controls the technical parameters in production. The sensory profile of the precursor product is based on a human sensory profiling process in which according to a test pattern various specific beverages have been produced from the same precursor product and profiled in human sensory terms (by a selected group of experienced individuals) by different settings of the technical parameters.

Alternatively or additionally, haptically perceptible savory effects of the food product can be produced or influenced user-controlled. These qualities can also be controllable by the automatic machines by the underlying technical parameters being varied by the automatic machine based on the predetermined sensory profile according to the quality which has been set (and which is desired) by the user.

With the process as claimed in the invention the extraction of the savory substances from the precursor product is directly influenced and controlled by those technical parameters being monitored or changed which act prior to the brewing process (such as for example the grind or compression of the ground coffee in the brew chamber) and/or during brewing (such as for example water pressure, water temperature, amount of water). Thus, at the end of the process step the entire brewed amount of coffee can be delivered as a drink portion. There is no intermediate storage or mixing of already brewed (stored) coffee beverages. The object is to produce the coffee within for example a maximum of 60 seconds (but typically less than 40 seconds) from the roasted coffee beans and to deliver it into a coffee cup or mug.

The process as claimed in the invention makes it possible, with consideration of the sensory profile of the precursor product, to produce the desired quality of the food product. This is greatly advantageous because by concomitant inclusion of the properties of the precursor product a much more accurately defined quality of the food product is achieved. This allows not only a much better approach to the desired quality of the food product, but also opens up a much larger range of versions in this respect. With automatic control on the one hand the desired taste, smell or composition of the food product can be much more accurately attained, and on the other hand more versions of the savory quality can be achieved. The method as claimed in the invention has very high adaptability and thus achieves much more precise reproducibility of the desired taste (or odor or feel in the mouth) of the food product.

Optionally, to prepare the sensory profile, in addition to human sensor profiling (which is prepared in a known manner by trained testers), chemical and/or physical analysis is done and a correlation between the analysis result and sensory profile can be computed.

The precursor product can be characterized even better by chemical analysis carried out in addition to the human sensory profiling, for example gas chromatography or mass spectroscopy. Within the framework of the method as claimed in the invention, this allows better adaptation to the precursor product and thus more accurate extraction of the savory substances. This enables improved agreement with the desired quality of the food product; this can make significant differences especially with changes of the precursor product. If moreover correlations are computed, these values can increase the quality of computation of the electronic transmission circuit, even if some of the information should not be known. In this way, under certain circumstances (relatively complex) human sensory profiling can be abandoned or the profiling need not be done for example with reference to all human sensory attributes (“bitterness”, “acid”, “body”, “fruitiness”, “floweriness”, “cream”, etc.) because certain human sensory attributes can be derived relatively easily based on chemical analysis.

Alternatively, a chemical analysis can be omitted or additional information about the precursor product can be obtained in some other way. Thus, for example it would be possible among others to undertake physical analyses. The result of any additional optional method which characterizes the precursor product can advantageously be integrated into the method as claimed in the invention.

In particular, the transmission circuit works according to the principle of an artificial neural network.

In this connection a neural network is an electronic circuit or a computer program which can learn or recognize complex patterns without an abstraction taking place about the rules underlying these patterns. Neural networks (or Kohonen networks) have already been used in different technical domains (such as for example image processing) and can therefore be assumed to be known. When the neural network is being trained, a set of input parameters (here a certain sensory profile and the values of the human sensory attributes) and a set of output parameters (here a certain set of technical parameter values) are stipulated and the neural network is adjusted to generate suitable output parameters for the input parameters. For this reason neural networks are especially well suited to the transmission circuit as claimed in the invention since with a neural network the values of a host of technical parameters which are necessary for producing the desired quality of the food product can be computed without a detailed theoretical rule system having to be set up. Neural networks must be trained, but for this reason are very flexible. This flexibility allows continuing adaption of the production process of the food product and is especially advantageous when the precursor product is a natural product with highly varying properties.

But transmission circuits can also be used which are not built according to the neural network principle. Suitable functions can be determined based on sensitivity analyses. With sensitivity analyses it is statistically determined which input parameter has a strong or measurable effect on a certain output parameter. As long as the incoming information leads to a suitable result all available and conceivable techniques can be used in the transfer circuit.

It can be optionally provided that the automatic machine for producing the food product delivers at least one accessory product. The accessory product in a coffee beverage is for example coffee cream, milk or sugar. But it can also be a spice or another accessory product which changes the smell and/or taste or the tactual sensation in the mouth.

The addition of any additional accessory product greatly enlarges the range of variations of quality of the food product. Due to the greater variation possibility, on the one hand the desired quality of the food product can be attained much more precisely and reproducibly, and on the other hand new sensory experiences in the consumption of the food product become possible. Moreover nutritional aspects of the food can be influenced (key words: food design, functional food) by for example diet requirements or special demands (allergies, diabetes, pregnancies, undernourishment or malnourishment, etc.) or preferences or limitations (for example also of an ethical or religious type) in the personal recipe. Accessory products can be all products which allow processing or charging by mechanical means, thus for example cow's milk, soy milk, cream, sugar, artificial sweeteners, alcoholic beverages, lemon juice or other fruit juices, acidifiers, dyes, thickeners, taste enhancers, foaming agents, salts, spices, minerals, trace elements, vitamin additives and much more. In principle the dosing and administration of medications are conceivable (cough syrups, mild analgesics, etc.).

But of course the use of accessory products can be omitted.

It has proven appropriate to include the storage interval of the precursor product in the setting of the technical parameters.

Often the length of storage of the precursor product has a certain effect on its properties. In order to be able to produce the desired quality of the food product independently of the length of storage, the transmission circuit must be able to access the real instantaneous properties of the precursor product. Thus changes of the precursor product can be compensated by including the length of storage in the calculation and the optimum technical parameters can be determined in a combination of its sensory profile.

The length of storage can be measured for example by a timer which is manually initialized by the user when the automatic machine is filled. But initialization can also be triggered automatically, for example by sensors which display the opening of the storage container seal or which measure the increase in the amount added (optically, mechanically, etc.) or the like. Initialization need not necessarily mean “reset to zero”. It can also be the existing length of storage of the precursor product up to use in the automatic machine as claimed in the invention.

In the case of coffee the length of storage can influence many different quality features; thus for example sweetness can diminish. By adapting the technical parameters (shorter length of brewing, lower temperature or the like) or the corresponding dosing of accessory products (for example more milk and/or sugar) this can be partially or completely compensated under certain circumstances.

The length of storage however can also be completely ignored. Or for example near the time of use of the precursor product measurement of its properties can be done. Ideally, before each application of the method as claimed in the invention the sensory profile of the precursor products can be currently and completely measured (but in most cases this would be associated with very high technical effort in practice). But it would be possible to be limited to one or several especially indicative parameters, for example relative moisture content, weight, color, acid content or the like.

Generally an automatic coffee maker as claimed in the invention manages with a single storage tank for the coffee beans. It is filled with a certain variety of roasted coffee beans. The transmission circuit is loaded with the human sensory profile which has been carefully prepared beforehand for the coffee beans in the storage tank. When the user changes the coffee beans, a different human sensory profile (i.e. a different neural network) must be loaded.

Of course applications are also conceivable in which the automatic coffee maker has two or more storage tanks which can be filled with different precursor products. Accordingly the transmission circuit must have several circuits or programs for determining the technical parameters from the human sensory profiles of the different precursor products. For each precursor product there must be specific human sensory profiling. Depending on the human sensory attributes which have been input by the user, the automatic device selects that precursor product with which the desired attributes are produced. If the desired attribute combination can be produced from several precursor products which are present in the storage tank (which will generally be the case) one of the precursor products can be chosen.

The food product is a ready-to-drink coffee beverage and roasted coffee beans are used as the precursor product.

A ready-to-drink coffee beverage can be produced in the most varied manner, and the range of variation of possible qualities of the coffee beverage is correspondingly large. This range of variation is additionally increased by the fact that roasted coffee beans as a precursor product are available in a great diversity of qualities; even the same product of the same variety can be subject to qualitative fluctuations. In coffee beverages the method as claimed in the invention is therefore especially advantageous because the exact sensory profile of the precursor product is considered and thus the desired quality of the coffee beverage is very easily reproduced. Moreover, controlled access to the entire range of variation of possible qualities of the coffee beverage is acquired. Thus it should also be possible to produce the same desired quality of the coffee beverage from the different varieties of coffee or roast products, by which independence from the precursor product is acquired (this of course applying not only to coffee).

In addition, the length storage for coffee beans has a decisive effect on their quality. Accessory products are also common (milk, cream, etc.). This is taken into account in different embodiments of the invention.

Within the framework of the invention there is also a system with the following products: several different coffee bean (mixtures), for each coffee bean (mixture) there being a specific human sensory profile and for each human sensory profile there being a matched neural network so that different coffee beans (mixtures) can be processed with the automatic coffee maker. The coffee beans (mixtures) are chosen such that the respectively assigned (different) profiles have an overlapping region in the human sensory profile. Thus the same human sensory attributes can be produced from different coffee beans.

The system can comprise several automatic coffee makers as claimed in the invention which produce a ready-to-drink portion of a coffee beverage with the human sensory attributes which have been input by the user from roasted coffee beans in a single process step.

To carry out the method as claimed in the invention, an automatic machine is used which contains the following parts:
a machine for extraction of savory substances which can be perceived by taste and/or smell from the precursor product (roasted coffee beans) and for their transfer into the food product (finished coffee beverage).
at least two process control elements for user-controlled setting of two adjustable technical parameters of the automatic machine and for influencing the extraction of the savory substances in order to be able to produce the desired quality of the food product, the process control element being a grinder for coffee beans.
and an electronic transmission circuit for setting the technical parameters of the process control elements, which, proceeding from the user-chosen values of the attributes and based on a predetermined sensory profile of the precursor product, controls the technical parameters for influencing the extraction of the savory substances in the production of the food product. In doing so one of at least two technical parameters is the grind of the grinder.

The automatic machine as claimed in the invention produces the coffee beverage in principle in a single (coherent) process step. This means that production of a drink portion (coffee cup, mug) is only started when the user has input all human sensory attributes and leads from grinding of the coffee beans (in the number of coffee beans necessary for the portion desired by the user) without intermediate storage (or process interruption) to the finished coffee beverage in the coffee cup or mug. The coffee beans are therefore ground in the automatic coffee maker itself, likewise the delivery of the ready-to-drink coffee beverage.

Preferably an automatic machine is used on which there is an input device on which the values of the human sensory attributes can be chosen by the user.

The advantage of the input device is the direct access to the values of the attributes which are to be regulated. If the desired setting takes place by such an interface, this is generally the simplest, fastest and most convenient approach and for an existing display it is also used at the same time for monitoring. Moreover this information transfer is less susceptible to problems.

It is of course also conceivable for the manufacturer to offer automatic coffee makers which make available the same choice with high quality coffee. It is furthermore conceivable for a large business with different locations to have the same machine at all locations (in order to simplify maintenance) and for the automatic coffee makers to be filled with different varieties of coffee which can be processed into always the same quality assortment based on profiling. The values of the attributes however need not necessarily be set by an input device on the automatic coffee maker; this information can be input into the automatic coffee makers in diverse ways. Among others, the values of the attributes can be established en route via any electronic devices and then transmitted for example by the Internet, LAN, GSM, Bluetooth or USB to the automatic coffee makers.

In particular the electronic transmission circuit of the automatic machines is provided with a data storage for one sensory profile of at least one precursor product.

For the method as claimed in the invention, the information contained in the sensory profile is critical and for this reason it is a great advantage if at least one sensory profile is stored in the transfer circuit and thus is quickly available. Preferably however two or more sensory profiles are stored. The more sensory profiles are stored, the more varieties of coffee can be processed as claimed in the invention.

An internal storage can however be omitted when a sensory profile is available in some other way, for example it is directly measured, a manual input exists or there is for example an external storage which can be interrogated if necessary. The precursor product could for example also be provided with its sensory profile which can be machine-read out (for example, a bar code on the packaging or the like).

Advantageously the automatic machine has a storage tank for the precursor product and a long term measurement device which is connected to the transmission circuit.

It is convenient and saves time if the automatic machine need not be reloaded with the precursor product with each use, but there is a storage tank. In the case of a quick, time-dependent change of the sensory profile it is also advantageous if the length of storage can be measured and it can be relayed to the transfer circuit. The storage tank can be additionally designed such that the storageability of the precursor product is improved (for example by cooling, UV protection, air exclusion, oxygen exclusion, protective gas, vacuum, dehumidification or the like).

Alternatively the automatic machine can be separately filled before each use, by which the need for a long term measurement device can be obviated. If a storage tank is installed, a long term measurement device can be omitted if the change of the sensory profile over time is ignored, this being extrapolated or even completely remeasured each time using one or more characterizing parameters. Several storage tanks can also be installed, the precursor products stored in them being able to be distinguished both in variety and also in length of storage. For purposes of simplified execution only a single decay display can be provided which reports to the user when the reserve is to be changed because the given length of storage has been exceeded.

An automatic machine is especially suitable which has a storage for recipes in which the technical parameters and/or the values of the human sensory attributes are stored and can be retrieved for user-controlled production.

An internal recipe storage for technical parameters and/or values of the human sensory attributes offers the advantages of prompt availability of the information, high autonomy and flexibility of the automatic machine and low fault susceptibility. A recipe describes the production of a food product of a desired quality and consists of its specific values of the technical parameters. When a user has decided that he wants a certain sensory quality of the coffee beverage more than once, he can instruct the automatic coffee maker via a “storage” button to store the technical parameters and the precursor products used as a data set in a so-called recipe storage so that the user subsequently no longer needs to input the values of the human sensory attributes, but simply can retrieve the stored recipe and the automatic coffee maker produces the corresponding coffee beverage.

But it is also possible to externally store the technical parameters and/or the values of the human sensory attributes externally, if necessary to interrogate them or manually set them directly.

Advantageously the automatic machine has a data interface for remote interrogation of sensory profiles of different precursor products.

A data interface for remote interrogation of sensory profiles makes it possible to use the automatic machine in a more versatile and flexible manner. The data interface can be used quite simply for connection of an external storage or can be used in a much more refined manner by there being data access for example via the Internet, WLAN, GSM, Bluetooth or similar channels. In addition to the sensory profiles, however the corresponding information for process control which sets the sensory profile in relation to the technical parameters can be transmitted. In the case of neural networks, the linkages can be transmitted or a clone can be produced.

The automatic machine can also be implemented without the data interface or with several data interfaces. If there is one or more interfaces, they can additionally be used differently, thus for example for retrieval from databases of user profiles and recipes on servers, for remote control of the automatic machines, for firmware updates, for obtaining additional information for training of the neural networks within the profiling process, for maintenance and for remote diagnoses in malfunctions and for adjustment of different automatic machines, to name a few.

It has proven useful that in the automatic machine the process control elements for producing a ready-to-drink coffee beverage in addition to the grinder for coffee beans are at least one of the following means or one of the following devices: A heater for water, a pressure generator for water, a volume sensor for water or a timer for the action time.

The grinder is for example an electronically adjustable grinder. This means that the grind can be set with an electronic circuit. In a conical grinder or a disk grinder for example the cone wheels or disks can be adjusted against one another by a motor for this purpose so that the set distance of the cone wheels or disks yields the desired fineness of the ground coffee. Depending on the grinder, the rotation speed or the length of operation can also be electronically set to change the grind of the coffee.

The water heater can produce for example a temperature which is independent of the coffee beverage which is to be produced. By adding some cold water the temperature of the water in the brew chamber (i.e. in the extraction of the savory substances) can accordingly be quickly (and thus separately also for each portion of the coffee beverage) adjusted down to a specific temperature. But it is also conceivable to heat the water in two stages, in the first stage a base temperature of for example 60° C. being held and in the second stage, depending on the requirement, the temperature being increased by the heater (for example by 10° C. or 20° C., depending on the sensory attributes to be achieved).

The pressure generator produces a pressure so that the brewing of the ground coffee (and thus the extraction of the savory substance) takes place at a pressure of at least 3 bar which is considerably above atmospheric pressure. Typically, in the brew chamber (i.e. in the extraction of the savory substances) a certain pressure in the range between 5 and 10 bar is used. The pressure generator can comprise a pump which produces a constantly high pressure of for example 20 bar. With a pressure reducing valve the pressure in the brew chamber can be brought to the desired value. Preferably the pressure is set by the ground coffee being compressed in the brew chamber with a piston so that the water can flow only slowly through the compressed ground coffee. By the compression of the ground coffee which is done correctly beforehand back-pressure (and thus a dynamic pressure) of the brew water is produced until the desired brew pressure is reached. Control of the back-pressure takes pressure for example by the ground coffee being pressed into the brew chamber with a certain force (depending on the dynamic pressure to be achieved) of the ground coffee compressor piston. The pressing force of the ground coffee compressor piston is then the technical parameter which generates the pressure of the pressure generator. The pressure generator can for example also comprise a controllable valve at the output of the brew chamber, analogously to the machine which is disclosed in the initially evaluated patent publication EP 1 909 905 A1.

The process control elements in the production process play a decisive role because the extraction process (brewing of the ground coffee in the brew chamber) is controlled by them. The technical parameters assigned to the process control elements have a distinct effect on the quality of the coffee beverage. If at least two of these process control elements are controlled by the method as claimed in the invention, the desired quality of the coffee beverage can be more precisely achieved and the range of variation of it maximized.

Control of only one process control element by the method as claimed in the invention is also possible, but in this form the potential of the invention is not exhausted. The more process control elements are incorporated into the method, the more distinctly the strengths of the method as claimed in the invention appear. In this sense an automatic coffee maker has preferably at least three or even at least four different adjustable process control elements (or production components provided with adjustment functions). Moreover the automatic machine as claimed in the invention or the method as claimed in the invention can have any other process control elements, thus for example a volume or weight sensor for ground and/or unground coffee, a temperature sensor for the water in brewing or for the coffee beverage, a volume or weight sensor and/or temperature sensor for accessory products such as milk, cream or the like, or a timer for the length of storage of the unground coffee and/or the accessory products.

In particular the values of one or more human sensory attributes such as for example “bitterness”, “acid”, “body”, “fruitiness”, “floweriness”, “cream”, etc. can be set directly.

The advantage of using human sensory attributes is that the quality of the coffee product can be changed in an easily intelligible and intuitive manner in the desired direction. Solely technical parameterization in this respect is not conclusive enough and cannot be directly used by the average user or consumer to obtain the desired coffee beverage.

Alternatively technical parameters can also be set on the input device, for example the amount of coffee and/or water, water temperature, action time, etc. Other parameters such as for example the temperature or volume of the coffee product can also be adjusted, or any mixture of different parameters and attributes.

An automatic machine is especially advantageous when it has a user guidance program which supports the user in the establishment of a user-defined recipe. This takes place by at least two automatically produced food products with different values of human sensory attributes being produced and submitted to the user together with a visual display of the pertinent value of the human sensory attributes for testing. Based on one of the food products the user can if necessary change the values of the human sensory attributes and can store the corresponding technical parameters and/or the values of the human sensory attributes in the recipe storage.

Since the method as claimed in the invention is directed at achieving the desired quality of the food product as accurately as possible, the desired quality must be defined with the corresponding precision. In order to optimally set the corresponding values of the human sensory attributes, it is highly advantageous if a user can be guided to the desired quality step-by-step by a test/tasting process. Controlled comparison of two or more food products of varying quality illustrates their differences, facilitates selection of the human sensory attributes which are to be optimized, and yields a good estimate for the required amount of change of the corresponding values (for example it is not clear to each coffee drinker how the different expressions of different “cream” versions feel).

Alternatively such a user guidance program can also be omitted and a tasting process can be carried out manually. Or a user guidance program can use means other than comparison of two food products of different quality which have been produced as claimed in the invention by for example a catalog of questions determining the desired quality of the food product, by prefabricated tasting samples being used, or the like.

Other advantageous embodiments and combinations of features of the invention will become apparent from the following detailed description and the totality of the claims.

### BRIEF DESCRIPTION OF THE DRAWINGS

The drawings used to explain the exemplary embodiment show the following:

FIG. 1 shows a schematic of the invention;

FIG. 2 shows a schematic of how a coffee beverage with the same human sensory attributes can be produced from two different coffee beans.

The same parts are provided with the same reference numbers in the figures.

### EMBODIMENTS OF THE INVENTION

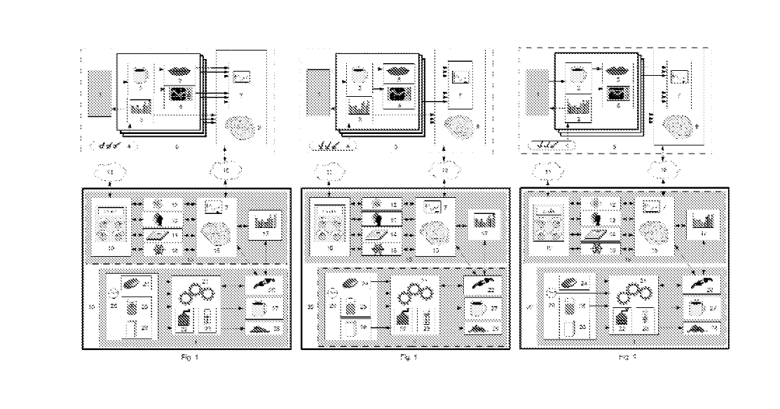

FIG. 1 schematically shows the method as claimed in the invention using one example of an automatic coffee maker.

In the upper part of FIG. 1, a profiling process 9 of one variety of coffee or a roast product is described. Here an automatic coffee maker 1 is used which is detailed in the lower part of FIG. 1. The manner of operation of the automatic coffee maker 1 is controlled by way of technical parameters 3 (grind, pressure, temperature, etc.) which are set within the framework of the profiling process 9 according to a certain test pattern 4. The test pattern 4 comprises different settings of the technical parameters 3 and for each setting (and each individual coffee variety or each individual roast product) generates a specific coffee beverage 2 which is profiled on the one hand in human sensory terms 5 and on the other is technically profiled 6.

The human sensory profiling 5 takes place typically by tasting of the coffee beverage by a group of specialized testers. Technical profiling 6 is the chemical measurement of ingredients (bitter substances, oils, etc.) or properties (pH, reactivity, etc.). Two profilings of a human sensory 5 or technical 6 type are acquired for each setting of the technical parameters 3 and are stored together in the sensory profile 7. Therefore for example 50 different coffee beverages are produced, the pertinent technical parameters being noted and stored in data sets, and the 50 coffee beverages are evaluated or qualified in sensory terms by the testers. Therefore there are 50 technical parameter sets (which indicate how the respective beverage was produced) and 50 pertinent human sensory profiles.

The sensory profile 7 and the corresponding technical parameters 3 are then correlated to one another by a neural network 8. In this way conclusions about the sensory profile 7 can be drawn from the technical parameters 3.

The lower part of FIG. 1 schematically shows an automatic coffee maker 30. The automatic coffee maker 30 consists of two main components, a coffee maker 1 and a process control 19. The coffee maker 1 is controlled by way of a machine interface 20 by the process control 19.

The process control 19 has a user interface 10 by which a user can operate the automatic coffee maker 30. In particular, the values of the human sensory attributes 12 of the coffee product (for example how much “bitterness”, “acid”, “body”, “fruitiness”, “floweriness”, “cream”, etc.) are set by the user interface 10 according to the user's wishes. One or more user profiles 13 can be assigned to the user which stores the individual values of the human sensory attributes 12 for one or more different coffee products. Furthermore the user profile 13 can also encompass still more, thus for example technical features such as for example the amount of the coffee product, information about ordering authorization of the products and account status (credit) or statistical data such as for example the number of coffee products consumed or the total of ingredients consumed daily.

The user interface 10 can also access recipes 14 which offer a choice of coffee beverages of different quality and which therefore constitute a good starting point for personal matching of the values of the human sensory attributes 12 to the desires of the user. Moreover, by way of the user interface 10 control signals 18 are input which for example initiate the production of a coffee beverage 27, turn power saving functions of the automatic coffee maker 30 on and off, enable choice of the correct sensory profile 7 for the corresponding precursor product 24, or the like.

A manual input device of the user interface 10 is preferably made such that manual inputs via controls such as switches, knobs, buttons, touch screens or the like are mounted directly on the automatic machine, advantageously the display of different parameters and/or values of attributes taking place in addition on a display or on controls.

One or more status displays for the operating state of the automatic device, information on user profiles 13 and recipes 14, error messages, level indications, etc. are integrated into the user interface 10. This information can be displayed by displays of all types, lamps, lights and also slides or other mechanical pointers or the like.

The process control 19 can however also be addressed externally via communications channels 11, for example via the Internet, WLAN, GSM, Bluetooth, USB bus or others. In this way the automatic coffee maker 30 can also be controlled by cellphone, computer, remote controls and other devices. Identification of the user and/or miscellaneous accounting can take place over the same channels, or there can also be a payment system in the user interface (against cash, with chips or credit cards or by credit in a user profile 13 or the like).

A neural network which is controlled by control signals 18 and which assumes computing tasks within the process control 19 accesses the values of the human sensory attributes 12, the user profiles 13 and the recipes 14. The neural network 15 corresponds in its manner of operation exactly to the neural network 8 which is trained in the profiling process 9 (i.e., the neural network 15 is a clone of the neural network 8).

Within the process control 19 the sensory profile desired by the user is fed to the neural network 15, and the neural network 15 determines from it the technical parameters 17 which lead to the desired sensory profile.

The technical parameters 17 computed by the neural network 15 in the process control 19 are transmitted to the coffee maker 1 via the machine interface 20. The technical parameters 17 thus control the coffee production process 21 which in this example contains only two controllable process control elements 22, 23: grind 22 of a variety of coffee A 24 and temperature 23 of the water 25.

The precursor product coffee variety A 24, the water 25 and an accessory product milk 26 are stored in a storage tank 29 with long term measurement. The storage tank 29 is divided into different chambers in which the coffee variety A 24, water 25 and milk 26 can be stored separately, the individual chambers each offering optimized storage conditions for the stored material (for example, dry and dark for coffee, cool for milk, etc.), and having a long term measurement device. The long term measurement is incorporated into the coffee production process 21 by its travelling via the machine interface 20 to the neural network 15 and being included there in the computations of technical parameters 17.

During the coffee production process 21 not only the coffee beverage 27 is produced, but grounds 28 also form which must be discarded.

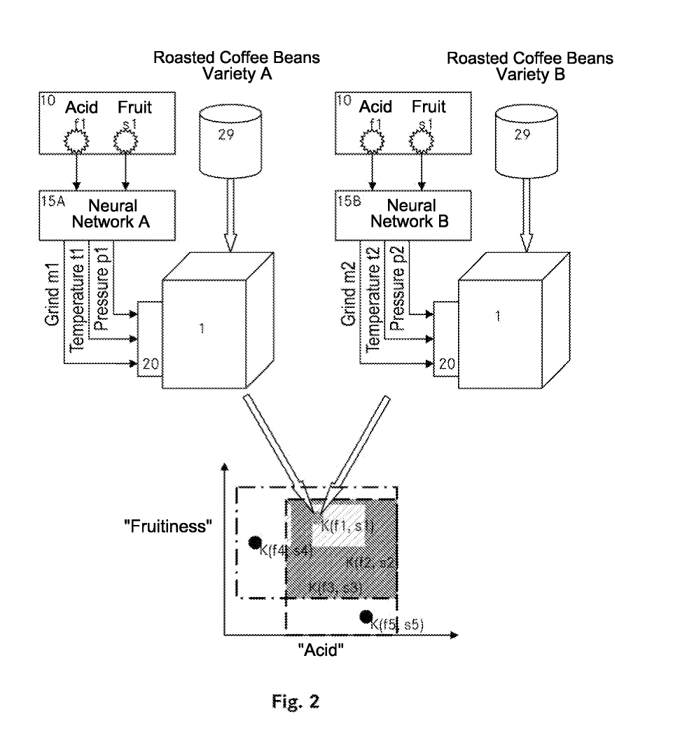

With the invention it is possible to produce the same coffee beverage from two (or more) different coffee roast products. This is explained below using FIG. 2:

The starting point is two different varieties of roasted coffee beans, variety A and variety B. They can for example differ from one another in that they originate from different varieties of plants and/or from different regions (for example low/high altitude) and/or are roasted differently.

Each of these two varieties A and B is processed with the fully automatic coffee maker as claimed in the invention. In one case, the storage tank 29 contains variety A and in the other case variety B. For this reason it is necessary that the human sensory profiling which belongs to the respective variety A or B be stored in the transmission circuit of the fully automatic coffee maker. Variety A is therefore processed with neural network A and variety B is processed with neural network B. In both cases the user inputs the same human sensory attributes via the user interface 10, for example the attributes “fruitiness” of strength f1 and “acid” of strength s1. The values f1 and s1 each represent a selected value in for example an at least ten-step scale (“1” . . . “10”). Preferably the human sensory attributes are given in percentages.

The neural network 15A for variety A at this point determines the suitable values of for example three technical parameters, the grind (value m1), temperature (value t1) and pressure (value p1) and outputs them to the machine interface 20. In the case of variety B, the neural network 15B which belongs to it determines three other parameter values m2, t2, and p2 for the for example three technical parameters.

In the case of variety A the coffee maker 1 grinds the coffee beans with a grind m1 and brews the resulting ground coffee with a temperature t1 and a pressure p1. A coffee beverage results as claimed in the invention with human sensory attributes K(f1, s1). Variety B is processed analogously with grind m2, temperature t2 and pressure p2 so that a coffee beverage with the same human sensory attributes K(f1, s1) results. Therefore two coffee beverage portions with the same taste K(f1, s1) are formed from two different varieties A and B.

Therefore this is possible because within the framework of the invention those technical parameters of coffee beverage preparation are influenced which affect the extraction of the savory substances. If the coffee is brewed under pressure (for example of at least 3 bars), the human sensory attributes “acid”, “bitterness”, “fruitiness”, “body”, etc. can be varied in a wide range. The range is wide such that in spite of different precursor products a major portion of the ranges overlap. (But it is not such that there is overlapping for any two different precursor products. If the precursor products are also different, under certain circumstances there is no overlapping, especially when a larger number of human sensory attributes is being considered).

This can be illustrated by the following example. It can be assumed that human sensory profiling of the “acid” of the coffee beverage is possible in a range from 0% to 100%. This means that the specialist testers give evaluations in a range of 0-100%; this corresponds to the objectively possible range of values. At this point, when the human sensory profile of variety A is being prepared for example by variation of the different technical parameters, a coffee beverage in the range of 10% to 70% can be attained. This means that the attribute “acid” for variety A in the best case reaches a strength of 70% but never a strength of 100%. For another variety B, in the human sensory profiling (in turn by variation of the technical parameters as claimed in the invention) a coffee beverage in the range of 30% to 90% can be produced. The decisive finding at this point is that in the range of 30% to 70% the human sensory profiles of varieties A and B overlap. Therefore a coffee beverage for example with an “acid” value of 50% (or 30% or 70%) can be produced both from variety A and also from variety B. Of course the technical parameters which lead to production of the “acid” value of 50% are different. (Here it can be sufficient for example for variety A to be ground more finely than variety B without the other technical parameters such as the brew temperature or brew pressure being set differently.)

The analogous applies to other human sensory attributes which are used for characterization of the coffee beverage. Typically at least three attributes which the user can set at will are made available by the coffee maker. (In practice not all theoretically conceivable attribute combinations are in fact technically possible. Certain human sensory attributes are mutually dependent and cannot be set independently of one another.).

FIG. 2 shows this on a simplified human sensory spectrum of human sensory attributes “acid”/“fruitiness”. There is a crosshatched overlapping region of the human sensory profiles of variety A (outlined with a broken line) and variety B (outlined with a dot-dash line). The coffee beverage K(f1, s1), K(f2, s2) and K(f3, s3) which are each defined by a pair of values of “acid” and “fruitiness” are in the overlapping region. They can be produced both from variety A and from variety B.

Conversely, for example a coffee beverage K(f5, s5) can only be produced from variety A and for example a coffee beverage K(f4, s4) can only be produced from variety B.

This fact can also be used when two or more different precursor products (for example variety A, B, C) are being profiled in human sensory terms according to the same test pattern. For each variety the electronic data which the transmission circuit requires (for example a neural network) are stored in the control of the automatic coffee maker. If variety A is in the storage tank, for example the neural network A is loaded. If conversely the storage tank is filled with variety B, the neural network B is loaded, etc.

A chain of restaurants or coffee shops can now set up the automatic coffee maker as claimed in the invention at different geographical locations and can provide the automatic coffee makers each with different precursor products. Based on the specific profiling of each precursor product as claimed in the invention, the same beverage, i.e. the beverage with the same human sensory attributes, can be produced at different locations (from different precursor products).

The described embodiment should be understood only as an illustrative example which can be modified or expanded within the framework of the invention.

The combination of the process control 19 and the coffee maker 1 into the automatic coffee maker 30 shown in FIG. 1 can also be easily eliminated by the machine interface 20 being made such that the neural network 15 can also be contacted with a distinct identification and also over distances. In this way the coffee maker 1 and process control 19 can be separated and for example several coffee makers can also be controlled by the same process control 19. This is especially advantageous when a neural network 15 is expensive and several coffee makers are available to the same circle of users.

In FIG. 1 the coffee beverage 27 is produced from coffee variety A as the precursor product 24, milk as the accessory product 26, and water 25. The number and type of raw materials can however be varied at will, thus for example different coffee bean varieties can be used to increase the diversity of the quality of the coffee beverage 27 in pure form or as mixtures or to more accurately attain the desired quality. In addition to milk 26, other accessory products such as for example cream or concentrated sweeteners can also be used.

In contrast to the profiling process 9 shown in FIG. 1, only either one human sensory profiling 5 or only one technical analysis 6 can also be done. It would also be possible to integrate technical analysis instruments into the machine 1 in order to be able to obtain current information about the precursor products 24.

The sensory profiles 7 need not be transmitted over a communications channel 16 as in FIG. 1 or stored in a neural network 15. It would also be conceivable for the precursor products 24 to be provided directly with their respective sensory profile 7 so that an automatic machine 30 can read it. In this exemplary embodiment the precursor products 24 for example would be purchased or delivered in containers which are provided with a machine-readable code (for example a one or two-dimensional bar code or the like). The automatic machine 30 then reads in the corresponding sensory profile 7 either when being filled with the precursor product 24 or prior to the coffee production process 24 and supplies it to the process control 19.

### REFERENCE NUMBER LIST

1 coffee maker
2 coffee beverage
3 technical parameters
4 test pattern
5 human sensory profiling
6 technical profiling
7 sensory profile
8 neural network
9 profiling process
10 user interface
11 communications channel
12 human sensory attributes
13 user profiles
14 recipes
15 neural network
16 communications channel
17 technical parameters
18 control signals
19 process control
20 machine interface
21 coffee production process
22 process control element
23 process control element
24 precursor product: coffee variety A
25 water
26 accessory product: milk
27 food product: coffee beverage
28 grounds
29 storage tank with measurement of length of storage
30 automatic coffee maker

1. Automatic machine (30) for user-controlled production of a liquid food product (27), specifically a ready-to-drink coffee beverage, from a precursor product (24), specifically from roasted coffee beans, comprising
a) a machine (1) for extracting savory substances which can be perceived by taste and/or smell from the precursor product (24) and for their transfer into the food product (27),
b) at least two process control elements (22, 23) for user-controlled setting of two adjustable technical parameters (17) of the automatic machine (30) and for influencing the extraction of the savory substances in order to be able to produce the desired quality of the food products (27),
c) one of the process control elements being a grinder for coffee beans (22),
characterized in that
d) there is an electronic transmission circuit (15) for setting the technical parameters (17) of the process control elements (22, 23), which, proceeding from user-selected values of human sensory attributes (12) and based on a predetermined sensory profile (7) of the precursor product (24), controls the technical parameters (17) for influencing the extraction of the savory substances in the production of the food product,
e) one of the at least two technical parameters (17) being the grind of the grinder (22), and that
f) the electronic transmission circuit (15) accesses the sensory profile (7) of the precursor product (24) which has been determined by a human sensory profiling process (9) in which according to the test pattern (4) different specific beverages (2) have been produced and profiled (5) in human sensory terms by different settings of the technical parameters (3) from the same precursor product (24).

2. Automatic machine (30) as claimed in claim 1, wherein there is an input device (10) on which the values of the human sensory attributes (12) can be chosen by the user.

3. Automatic machine (30) as claimed in claim 1, wherein the electronic transfer circuit (15) is provided with a data storage for one sensory profile (7) of at least one precursor product (24).

4. Automatic machine (30) as claimed in claim 1, wherein it has a storage tank (29) for the precursor product (24) and a long term measurement device (29) which is connected to the transfer circuit (15).

5. Automatic machine (30) as claimed in claim 1, wherein it has a storage for recipes (14) in which the technical parameters (17) and/or the values of the human sensory attributes (12) can be stored and can be retrieved for user-controlled production.

6. Automatic machine (30) as claimed in claim 1, wherein it has a data interface (16) for remote interrogation of sensory profiles (7) of different precursor products (24).

7. Automatic machine (30) as claimed in claim 1, wherein the process control elements (22, 23) for producing a ready-to-drink coffee beverage (27) in addition to the grinder for coffee beans (22) are at least one of the following means:
g) a heater for water (23),
h) a pressure generator for water,
i) a volume sensor for water,
j) a timer for the action time.

8. Automatic machine (30) as claimed in claim 1, wherein the values of one or more human sensory attributes (12) such as for example “bitterness”, “acid”, “body”, “fruitiness”, “floweriness”, “cream”, etc. can be set directly on the input device (10).

9. Automatic machine (30) as claimed in claim 1, wherein it has a user guidance program which supports the user in the establishment of a user-defined recipe (14) by at least two automatically produced food products (27) with different values of the human sensory attributes (12) being produced and submitted to the user together with a visual display of the pertinent values of the human sensory attributes (12) for testing, and wherein based on one of the food products (27) the user can if necessary change the values of the human sensory attributes (12) and wherein the corresponding technical parameters (17) and/or the values of the human sensory attributes (12) can be stored in the recipe storage (14).

10. System with an automatic machine as claimed in claim 1, characterized by two or more precursor products and by one human sensory profile at a time for each of the indicated precursor products.

11. System as claimed in claim 10, characterized by at least two automatic machines.

12. Method for user-controlled production of a liquid food product (27), specifically a ready-to drink coffee beverage, from a precursor product (24), specifically from roasted coffee beans,
a) savory substances which can be perceived by taste and/or smell being extracted from the precursor product (24) by the automatic machine (30) and transferred into the food product (27),
b) the automatic machine comprising a machine which as the process control element has a grinder for coffee beans (22), and
c) by user-controlled setting of at least two adjustable technical parameters of the automatic machine (30) the extraction of savory substances being influenced in order to produce the desired quality of the food product (27),
wherein
d) setting of the technical parameters (17) takes place by a user-controlled electronic transmission circuit (15) which proceeding from user-selected values of human sensory attributes (12) and based on a predetermined (9) sensory profile (7) of the precursor product (24) controls the technical parameters (17) for influencing the extraction of the savory substances in the production of the food product, wherein
e) one of the at least two technical parameters (17) is the grind of the grinder (22), and wherein
f) the sensory profile (7) of the precursor product (24) is based on the human sensory profiling process (9) in which according to the test pattern (4) different specific beverages (2) have been produced from the same precursor product (24) and profiled (5) in human sensory terms by different settings of the technical parameters (3).

13. Method as claimed in claim 12, wherein a chemical analysis (6) is carried out in addition to the human sensory profiling (5) to prepare the sensory profile (7) and wherein a correlation is computed.

14. Method as claimed in claim 12, wherein the transmission circuit (15) works according to the principle of a neural network.

15. Method as claimed in claim 12, wherein the automatic machine (30) for producing a food product (27) supplies at least one accessory product (26).

16. Method as claimed in claim 12, wherein in the setting of the technical parameters (17) the length of storage (29) of the precursor product (24) is included in the calculation.
